(19) United States
(12) Patent Application Publication
(10) Pub. No.: US 2025/0193665 A1
(43) Pub. Date: Jun. 12, 2025

(54) CREDENTIAL MANAGEMENT ACROSS MULTIPLE DEVICES FOR WIRELESS NETWORK ACCESS

(71) Applicant: CenturyLink Intellectual Property LLC, Denver, CO (US)

(72) Inventors: Dean Ballew, Sterling, VA (US); John R.B. Woodworth, Amissville, VA (US)

(73) Assignee: CenturyLink Intellectual Property LLC, Denver, CO (US)

(21) Appl. No.: 18/965,344

(22) Filed: Dec. 2, 2024

Related U.S. Application Data
(60) Provisional application No. 63/607,433, filed on Dec. 7, 2023.

(51) Int. Cl. H04W 12/06; H04W 12/61; H04W 76/10

(52) U.S. Cl. CPC H04W 12/06; H04W 12/61; H04W 76/10

(57) ABSTRACT

Novel tools and techniques are provided for implementing credential management across multiple devices for wireless network access. In examples, in response to receiving, from a client device, an authentication request for connection to a wireless network, a wireless access point device sends, to an administrator device, an authorization request for establishing a connection between the client device and the wireless network; receives, from the administrator device, an authorization response; and, when the authorization response indicates to provide access, generates and associates a credential for and with the client device, sets one or more time-to-live (“TTL”) values for the credential, and sends the credential to the client device. In response to receiving another authentication request from the client device, including the credential, the wireless access point device determines whether a first TTL value is valid; when the first TTL value is valid, approves the authentication request and establishing the connection.

### CROSS-REFERENCE TO RELATED APPLICATIONS

This application claims the benefit of U.S. Provisional Application No. 63/607,433 filed Dec. 7, 2023, entitled “Credential Management Across Multiple Device for Wireless Network Access,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing network access functionality, and, more particularly, to methods, systems, and apparatuses for implementing credential management across multiple devices for wireless network access.

### BACKGROUND

Adding devices to a customer premises Wi-Fi network is typically performed through credentials that are shared among many devices and can potentially be recovered if a device is lost or stolen. This requires new credentials to be created and reconfigured across all affected devices, which can be a tedious and/or a non-trivial endeavor. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing credential management across multiple devices for wireless network access, in accordance with various embodiments.

FIGS. 2A and 2B depict various example systems illustrating various sets of example credential data that are used by a wireless access point device when implementing credential management across multiple devices for wireless network access, in accordance with various embodiments.

FIGS. 3A and 3B depict flow diagrams illustrating an example method for implementing credential management across multiple devices for wireless network access, in accordance with various embodiments.

FIGS. 4A-4E depict flow diagrams illustrating another example method for implementing credential management across multiple devices for wireless network access, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

Various embodiments provide tools and techniques for implementing network access functionality, and, more particularly, to methods, systems, and apparatuses for implementing credential management across multiple devices for wireless network access.

In various embodiments, a wireless access point device receives, from a client device, a first authentication request for connection to a wireless network; sends, to the client device, a prompt to either provide a credential or to request a new credential; and, in response to receiving a request for a new credential, performs first tasks. The first tasks include sending, to an administrator device, a first authorization request for establishing a connection between the client device and the wireless network; receiving, from the administrator device, a first authorization response to the first authorization request; and based on the first authorization response indicating to provide access to the client device, performing second tasks. The second tasks include generating and associating a first credential for and with the client device; setting a first time-to-live (“TTL”) value for the first credential; and sending the first credential to the client device. The first tasks further include receiving a second authentication request from the client device, including the first credential; determining whether the first TTL value for the first credential is valid; and when the first TTL value for the first credential is valid, approving the second authentication request for the client device, and establishing a connection between the client device and the wireless network via the wireless access point device.

The various aspects provide unique credentials and an associated TTL period that once expired can permanently remove access to each device. For each session, when first established, a unique set of credentials may be used that is bound to an identifier (e.g., a unique media access control (“MAC”) address, a (unique) serial number, a (unique) combination of model number and device number, or a unique IP address, etc.) of the device. A TTL period is associated with the session that will be renewed through connectivity. If the connectivity is broken for longer than the TTL period, connectivity may be denied, and, in some cases, the credentials may be automatically removed.

These and other aspects of the methods and system for implementing credential management across multiple devices for wireless network access are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well.

By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including: receiving, by a wireless access point device and from a client device, a first authentication request for connection to a wireless network; sending, by the wireless access point device and to the client device, a prompt to cither provide a credential or to request a new credential; and in response to receiving a request for a new credential, performing first tasks. The first tasks include sending, by the wireless access point device and to an administrator device, a first authorization request for establishing a connection between the client device and the wireless network; receiving, by the wireless access point device and from the administrator device, a first authorization response to the first authorization request; and based on the first authorization response indicating to provide access to the client device, performing second tasks. The second tasks include generating and associating, by the wireless access point device, a first credential for and with the client device; setting, by the wireless access point device, a first time-to-live (“TTL”) value for the first credential; and sending, by the wireless access point device, the first credential to the client device. The first tasks further include receiving, by the wireless access point device, a second authentication request from the client device, including the first credential; determining, by the wireless access point device, whether the first TTL value for the first credential is valid; and when the first TTL value for the first credential is valid, approving, by the wireless access point device, the second authentication request for the client device, and establishing, by the wireless access point device, a connection between the client device and the wireless network via the wireless access point device.

In some examples, the first credential is a temporary unique credential that is unique to and associated with a media access control (“MAC”) address of the client device. In examples, the first TTL value corresponds to a first time period, during which the first credential is valid, the first time period corresponding to a duration of a first session between the client device and the wireless access point device. In such examples, the second tasks further include setting, by the wireless access point device, a second TTL value for the first credential. In some cases, the second TTL value corresponds to a second time period, during which the first credential is valid, a start of the second time period following termination of the first time period. In some instances, setting the first TTL value and the second TTL value for the first credential are based on the first authorization response indicating to provide access to the client device. In some examples, the second tasks further include storing, in a data storage device, the first credential, the first TTL value, and the second TTL value, the first credential being associated with an identifier that is associated with the client device.

In some embodiments, the method further includes, when the first TTL value for the first credential is valid, initiating, by the wireless access point device, the first session; and, prior to expiration of the first time period corresponding to the first TTL value, sending, by the wireless access point device and to the administrator device, a second authorization request. The method further includes receiving, by the wireless access point device and from the administrator device, a second authorization response indicating whether to extend the first time period while the first session is continuing, by changing the first TTL value. The method further includes, when the second authorization response indicates that the first time period should not be extended, causing, by the wireless access point device, the first session to be terminated upon the expiration of the first time period corresponding to the first TTL value. Alternatively, the method further includes, when the second authorization response indicates that the first time period should be extended, modifying, by the wireless access point device, the first TTL value based on the second authorization response to extend the first time period.

According to some embodiments, the method further includes, based on a determination that the first session has terminated, receiving, by the wireless access point device, a third authentication request from the client device, including the first credential; and determining, by the wireless access point device, whether the second TTL value for the first credential is valid. The method further includes, when the second TTL value for the first credential is valid, approving, by the wireless access point device, the third authentication request for the client device, and re-establishing, by the wireless access point device, a connection between the client device and the wireless network via the wireless access point device.

In some embodiments, the method further includes, in response to receiving a second credential, performing third tasks including determining, by the wireless access point device, whether the second credential matches a permanent credential or a temporary credential. The third tasks further include, based on a determination that the second credential matches one of the permanent credential or the temporary credential, approving, by the wireless access point device, the first authentication request for the client device, and establishing, by the wireless access point device, a connection between the client device and the wireless network via the wireless access point device. In examples, the permanent credential has a first TTL value that corresponds to one of a permanent first time period, an extended first time period, an automatically resetting first time period, or a periodically resetting first time period, or the like. In some cases, the temporary credential has a first TTL value that corresponds to a finite-duration first time period or limited-duration first time period.

In examples, the client device includes one of a user device, an Internet of Things (“IoT”) device, or an appliance. In some cases, the user device includes one of a desktop computer, a laptop computer, a tablet computer, a smart phone, or a portable gaming device, or the like. In some instances, the IoT device includes one of a wireless network-capable sensor device, a wireless network-capable light bulb, or a wireless network-capable appliance, or the like. In some examples, the appliance or wireless network-capable appliance includes one of a wireless network-capable home office device, a wireless network-capable kitchen appliance, a wireless network-capable entertainment system, a wireless network-capable security system, or a wireless network-capable home appliance, or the like. In some embodiments, the administrator device includes an administrator user device including one of a desktop computer, a laptop computer, a tablet computer, or a smart phone, or the like.

According to some embodiments, generating the first credential includes one of receiving a temporary password from the administrator device and generating the first credential based on the temporary password; automatically generating a random temporary password; or hashing a permanent password of the wireless network with a MAC address of the client device.

In another aspect, the technology relates to a wireless access point device, including at least one first processor; and a first non-transitory computer readable medium communicatively coupled to the at least one first processor. The first non-transitory computer readable medium has stored thereon computer software including a first set of instructions that, when executed by the at least one first processor, causes the wireless access point device to: receive, from a client device, an authentication request for connection to a wireless network; send, to the client device, a prompt to provide a credential; and, in response to receiving a first credential from the client device, performing first tasks. The first tasks include determining whether the first credential is valid; based on a determination that the first credential is valid, determining whether a first TTL value for the first credential is valid, wherein the valid first credential is unique to and associated with an identifier of the client device. The first tasks further include, when the first TTL value for the first credential is valid, approving the authentication request for the client device, establishing a connection between the client device and the wireless network via the wireless access point device, and initiating a first session between the client device and the wireless network, wherein the first TTL value includes a first time period corresponding to the first session. Alternatively, the first tasks further include, when the first TTL value for the first credential is no longer valid, determining whether a second TTL value is valid, the second TTL value corresponding to a second time period, during which the first credential is valid, a start of the second time period following termination of the first time period. The first tasks further include, when the second TTL value for the first credential is valid, approving the authentication request for the client device, re-establishing the connection between the client device and the wireless network via the wireless access point device, and initiating a second session between the client device and the wireless network; and when the first credential is not valid or when both the first and second TTL values are not valid, denying the client device access to the wireless network.

In some embodiments, the identifier includes a MAC address of the client device. In examples, the first tasks further include, while the first session is active and prior to expiration of the first time period corresponding to the first TTL value, sending, to an administrator device, an authorization request; and receiving, from the administrator device, an authorization response indicating whether to extend the first time period while the first session is continuing, by changing the first TTL value. The first tasks further include, when the authorization response indicates that the first time period should not be extended, causing the first session to be terminated upon expiration of the first time period corresponding to the first TTL value; and when the authorization response indicates that the first time period should be extended, modifying the first TTL value based on the authorization response to extend the first time period.

In yet another aspect, the technology relates to a method, including receiving, by a wireless access point device and from a client device, an authentication request for connection to a wireless network; determining, by the wireless access point device, whether a credential has been associated with the client device; based on a determination that a temporary credential has been associated with the client device, sending, by the wireless access point device and to the client device, a prompt to provide a credential; and in response to receiving a first credential from the client device, performing first tasks. The first tasks include determining, by the wireless access point device, whether the first credential is valid; and based on a determination that the first credential is valid, determining whether a first TTL value for the first credential is valid, wherein the valid first credential is unique to and associated with an identifier of the client device. The first tasks further include, when the first TTL value for the first credential is valid, approving the authentication request for the client device, establishing a connection between the client device and the wireless network via the wireless access point device, and initiating a first session between the client device and the wireless network, wherein the first TTL value includes a first time period corresponding to the first session.

In some examples, the identifier includes a MAC address of the client device. In examples, the first tasks further include, when the first TTL value for the first credential is no longer valid, determining, by the wireless access point device, whether a second TTL value is valid, the second TTL value corresponding to a second time period, during which the first credential is valid, a start of the second time period following termination of the first time period. The first tasks further include, when the second TTL value for the first credential is valid, approving, by the wireless access point device, the authentication request for the client device, re-establishing, by the wireless access point device, the connection between the client device and the wireless network via the wireless access point device, and initiating, by the wireless access point device, a second session between the client device and the wireless network.

In some embodiments, the first tasks further include, while the first session is active and prior to expiration of the first time period corresponding to the first TTL value, sending, by the wireless access point device and to an administrator device, a first authorization request; and receiving, by the wireless access point device and from the administrator device, a first authorization response indicating whether to extend the first time period while the first session is continuing, by changing the first TTL value. The first tasks further include, when the first authorization response indicates that the first time period should not be extended, causing, by the wireless access point device, the first session to be terminated upon expiration of the first time period corresponding to the first TTL value. Alternatively, the first tasks further include, when the first authorization response indicates that the first time period should be extended, modifying, by the wireless access point device, the first TTL value based on the first authorization response to extend the first time period.

According to some embodiments, the method further includes, based on a determination that a credential has not been associated with the client device, sending, by the wireless access point device and to the client device, a prompt to request a new credential; and, in response to receiving a request for a new credential, performing second tasks. In some examples, the second tasks further include sending, by the wireless access point device and to the administrator device, a second authorization request for establishing a connection between the client device and the wireless network; receiving, by the wireless access point device and from the administrator device, a second authorization response to the second authorization request; and based on the second authorization response indicating to provide access to the client device, performing third tasks. The third tasks include generating and associating, by the wireless access point device, a second credential for and with the client device; setting, by the wireless access point device, a first TTL value for the second credential; setting, by the wireless access point device, a second TTL value for the second credential; and sending, by the wireless access point device, the second credential to the client device.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

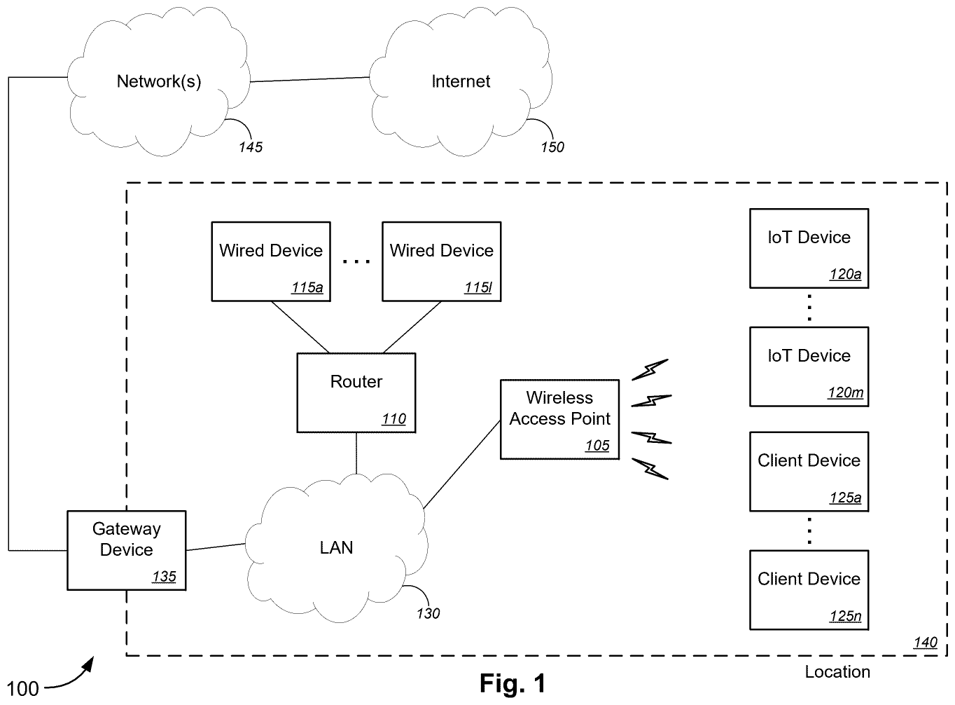

FIGS. 1-5 illustrate some of the features of the method, system, and apparatus for implementing network access functionality, and, more particularly, to methods, systems, and apparatuses for implementing credential management across multiple devices for wireless network access, as referred to above. The methods, systems, and apparatuses illustrated by FIGS. 1-5 refer to examples of different embodiments that include various components and operations, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing credential management across multiple devices for wireless network access, in accordance with various embodiments.

In the non-limiting embodiment of FIG. 1, example system 100 includes a wireless access point device 105, a router 110, zero or more wired devices 115a-115l (collectively, “wired devices 115” or the like), zero or more IoT devices 120a-120m (collectively, “IoT devices 120” or the like), one or more client devices 125a-125n (collectively, “client devices 125” or the like), a local area network (“LAN”) 130, and a gateway device 135. Herein, l, m, and n are non-negative integer numbers that may be either all the same as each other, all different from each other, or some combination of same and different (e.g., one set of two or more having the same values with the others having different values, a plurality of sets of two or more having the same value with the others having different values, etc.). In some examples, the router 110 may be part of the wireless access point device 105. In examples, the wireless access point device 105, the router 110, the zero or more wired devices 115, the zero or more IoT devices 120, the one or more client devices 125, the LAN 130, and the gateway device 135 may be disposed at location 140. In some examples, location 140 includes customer premises including, but not limited to, one of a residential customer premises, a business customer premises, a corporate customer premises, an enterprise customer premises, an education facility customer premises, a medical facility customer premises, or a governmental customer premises, and/or the like. System 100 further includes network(s) 145 and Internet 150. Gateway device 135 couples wireless access point device 105 (and any wirelessly connected devices 120 and 125) and router 110 (and any wired devices 115 connected thereto) via LAN 130, and couples LAN 130 (and devices connected thereto) with Internet 150 via network(s) 145.

In examples, each client device 125 includes one of a user device, an IoT device (e.g., IoT device 120), or an appliance, or the like. In some cases, the user device includes one of a desktop computer, a laptop computer, a tablet computer, a smart phone, or a portable gaming device, or the like. In some instances, the IoT device 120 each includes one of a wireless network-capable sensor device, a wireless network-capable lighting device, or a wireless network-capable appliance, or the like. In some cases, the wireless network-capable sensor device includes at least one of a temperature sensor, a humidity sensor, a light sensor, a motion sensor, an infrared sensor, a camera, or a microphone, or the like. In some instances, the wireless network-capable lighting device includes one of a light bulb, a lamp, or a lighting fixture, or the like. In some examples, the appliance or wireless network-capable appliance includes one of a wireless network-capable home office device, a wireless network-capable kitchen appliance, a wireless network-capable entertainment system, a wireless network-capable security system, or a wireless network-capable home appliance, or the like.

In some cases, the wireless network-capable home office device includes one of a printer, a scanner, a projector, a copier, etc., each configured for wireless network connectivity and wireless communication or data transfer. In some instances, the wireless network-capable kitchen appliance includes one of a refrigerator, a dish washer, an oven, a kitchen range, a microwave, a rice cooker, a pressure cooker, an air fryer, a sous vide machine, etc., each configured for wireless network connectivity and wireless communication or data transfer. In some examples, the wireless network-capable entertainment system includes one of a television, a video recording device, a video playback device, a gaming console, a content streaming device, a sound system, etc., each configured for wireless network connectivity and wireless communication or data transfer. In examples, the wireless network-capable security system includes one of one or more cameras, one or more motion detectors, one or more doorway locks, a security interface device, etc., each configured for wireless network connectivity and wireless communication or data transfer. In some embodiments, the wireless network-capable home appliance includes one of a washing machine, a clothes dryer, a wash tower, a garage door opener, a motorized doorway, a motorized window, a motorized window covering, a lighting system, etc., each configured for wireless network connectivity and wireless communication or data transfer.

In some embodiments, one or more client devices-such as a device(s) associated with a user that owns, or is otherwise associated with, location 140-each serves as an administrator device including an administrator user device including one of a desktop computer, a laptop computer, a tablet computer, or a smart phone, or the like. One or more wireless devices (e.g., IoT device(s) 120 and/or client device(s) 125), although primarily connected wirelessly to LAN 130 via wireless access point device 105 (as depicted, e.g., in FIG. 1 by lightning bolt symbols), may alternatively be connected to LAN 130 (as wired device(s) 115) via router 110. Gateway device 135 includes at least one of a modem, a network interface device, or an optical network terminal, and/or the like.

According to some embodiments, network(s) 145 may each include, without limitation, one of a LAN, including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 145 may include an access network of the service provider (e.g., an Internet service provider (“ISP”)). In another embodiment, the network(s) 145 may include a core network of the service provider and/or the Internet.

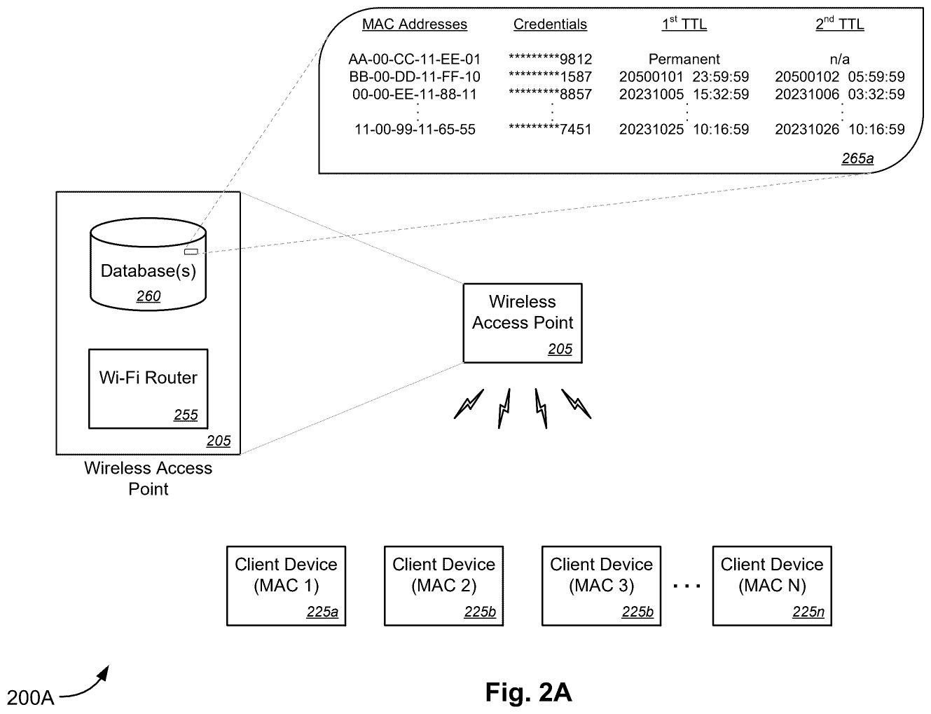

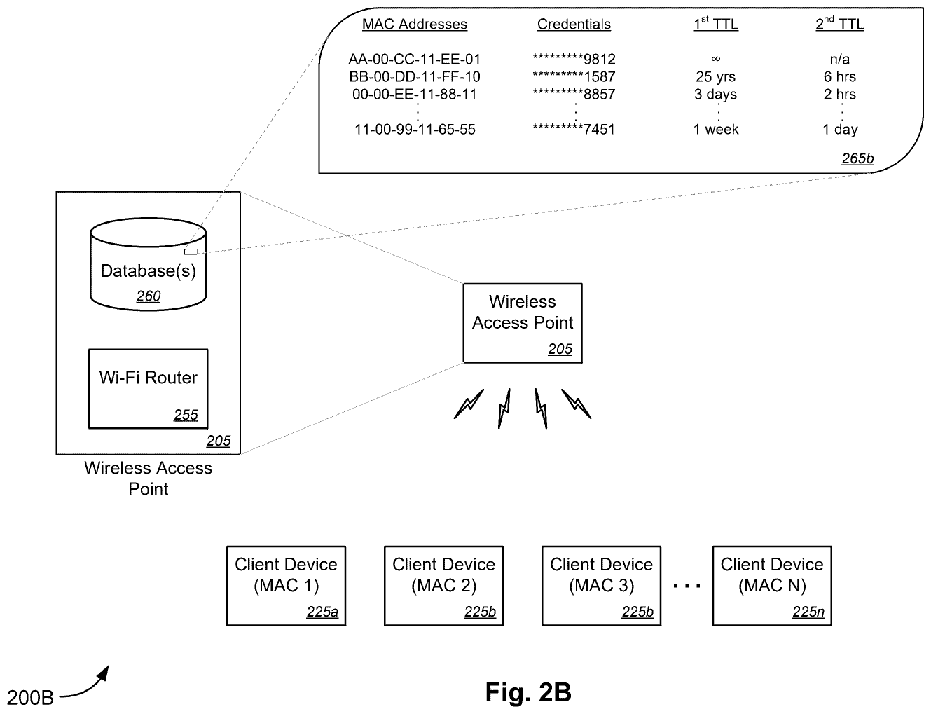

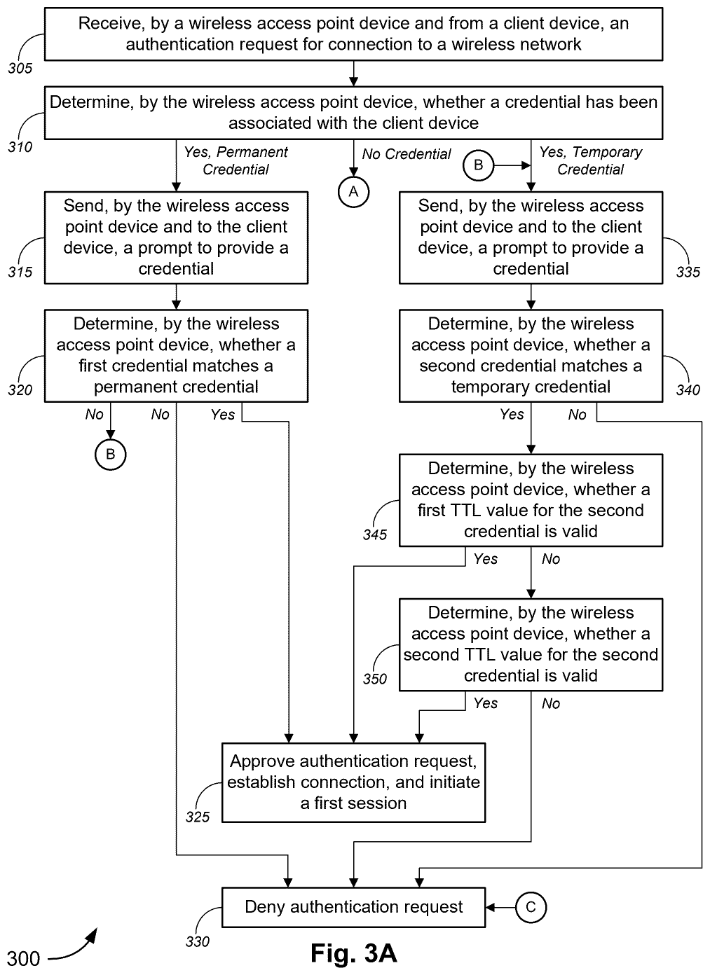

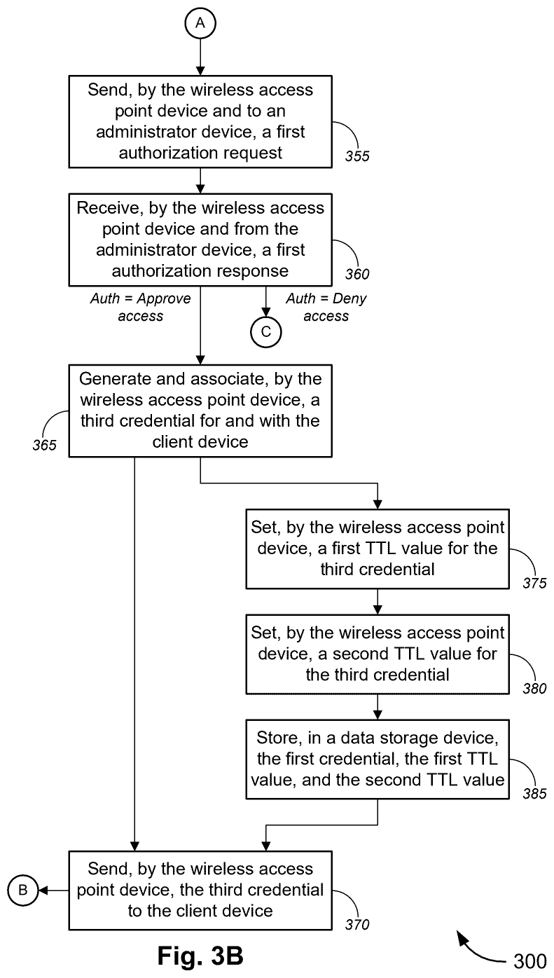

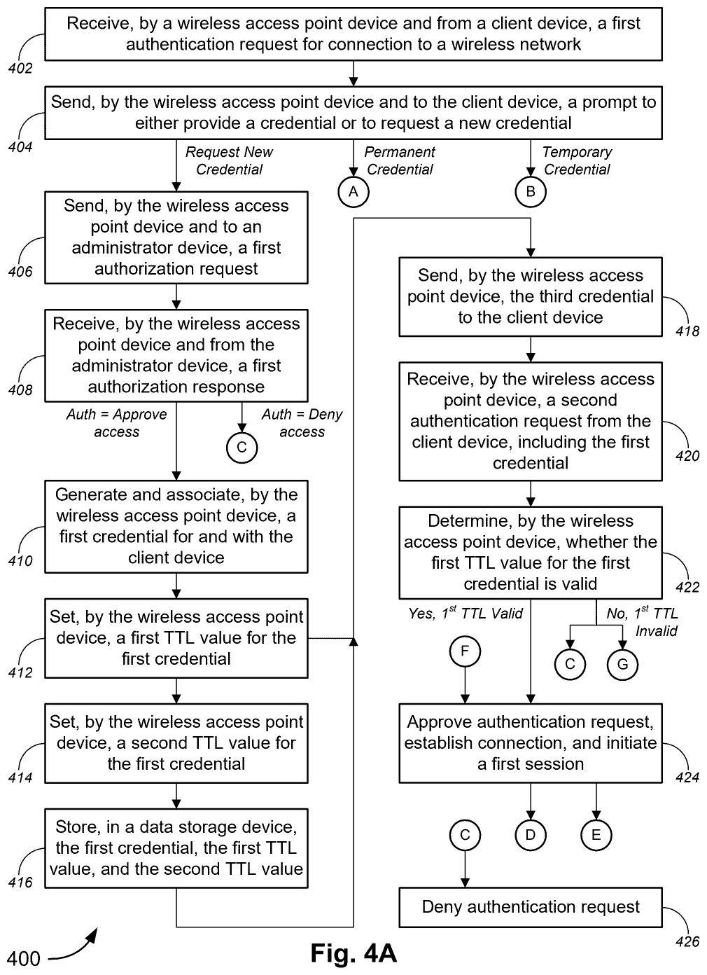

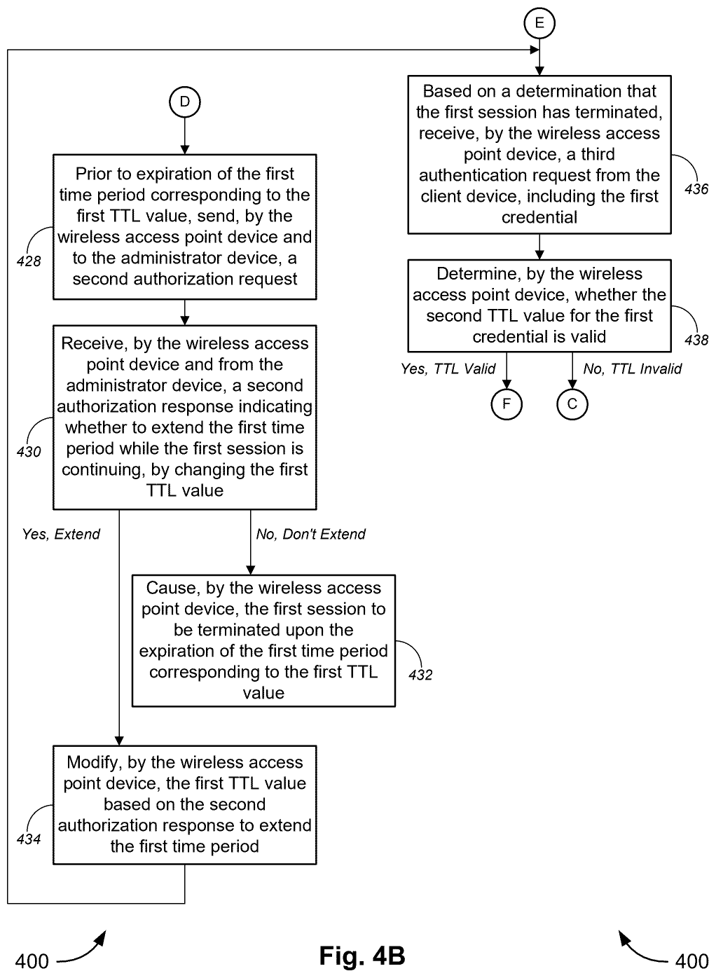

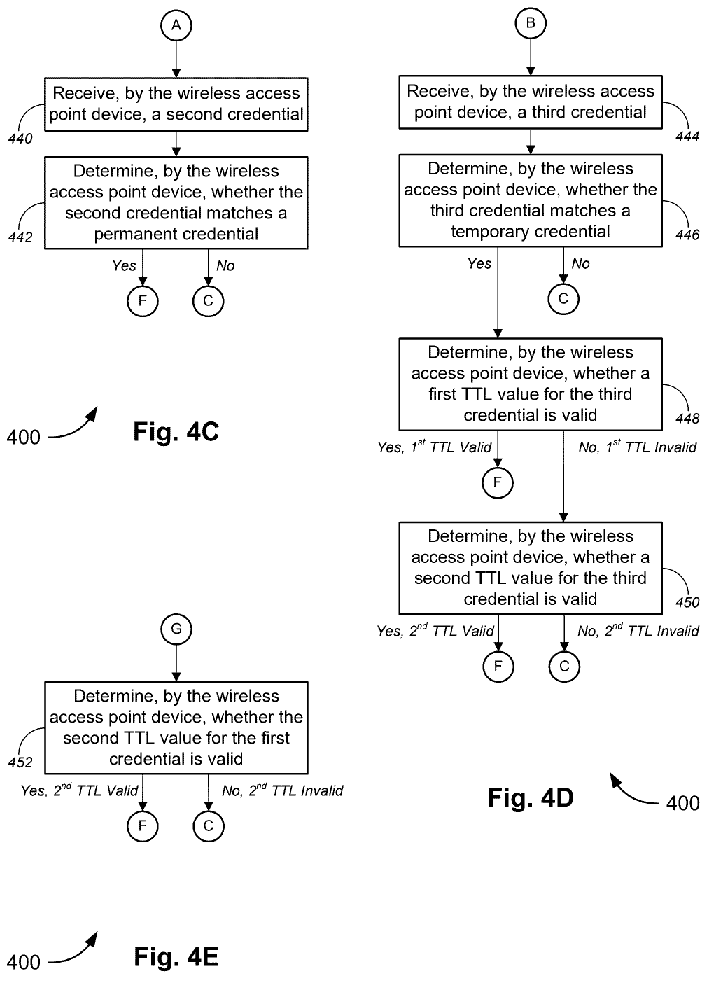

In operation, wireless access point device 105 may perform methods for implementing credential management across multiple devices for wireless network access, as described in detail with respect to FIGS. 2A-4E. For example, the sets of example credential data 265a and 265b as shown with respect to FIGS. 2A and 2B, and example methods 300 and 400 as shown with respect to FIGS. 3A-3B and 4A-4E, respectively, may be applied with respect to the operations of example system 100 of FIG. 1.

FIGS. 2A and 2B (collectively, “FIG. 2”) depict various example systems 200A and 200B illustrating various sets of example credential data that are used by a wireless access point device when implementing credential management across multiple devices for wireless network access, in accordance with various embodiments. In some embodiments, wireless access point device 205 and client devices 225a-225n of FIG. 2 may be similar, if not identical, to the wireless access point device 105 and client devices 125a-125n (and/or IoT device 120a-120m), respectively, of system 100 of FIG. 1, and the description of these components of system 100 of FIG. 1 are similarly applicable to the corresponding components of FIG. 2.

In FIG. 2, wireless access point device 205 communicatively couples with at least one of one or more client devices 225a-225n (collectively, “client devices 225”), at least for purposes of allowing each client device 225 to request access to a wireless network (e.g., LAN 130 of FIG. 1, or the like). Once a client device 225 has been authenticated and approved for connection to the wireless network, the wireless access point device 205 provides a connection path(s) between the client device 225 and the wireless network. Wireless access point device 205 includes Wi-Fi router 255 and database(s) 260. Each client device 225 has a media access control (“MAC”) address associated with it. For each client device 225 that has been provided with access to the wireless network, credentials for accessing the wireless network (whether provided by a user associated with the client device 225, generated by the client device 225, or generated by the wireless access point device 205) may be stored on database(s) 260 associated with corresponding MAC address. Where one or more time-to-live (“TTL”) values are set for a particular credential, these values may also be stored on the database(s) 260 associated with the corresponding MAC address and corresponding credential(s). In some examples, the TTL values may include a first TTL value and a second TTL value. In examples, the first TTL value corresponds to a first time period, during which the corresponding credential is valid, the first time period corresponding to a duration of a first session between the client device 225 and the wireless access point device 205. In such examples, the second TTL value corresponds to a second time period, during which the corresponding credential is valid, a start of the second time period following termination of the first time period. In some examples, the credentials may each include one of a permanent password or a temporary password.

As shown in the non-limiting example 200A of FIG. 2A, credential data 265a may include credentials, first TTL values, and second TTL values associated with corresponding MAC address that is associated with a client device among the one or more client devices 225a-225n. The first TTL values are listed as one of a permanent value for the first time period, an expiration date and time value(s) for the first time period that is years in the future, an expiration date and time value(s) for the first time period that has expired, or an expiration date and time value(s) for the first time period that is one or more minutes, one or more hours, one or more days, one or more weeks, or one or more months in the future, or the like. The second TTL values are listed as one of blank or not applicable, or an expiration date and time value(s) for the second time period (after the expiry of the first time period) that is minutes, hours, days, or weeks, or the like. In examples, the credentials corresponding to a client device 225 or its corresponding MAC address may be encrypted and the encrypted credential 270 may be sent from the wireless access point 205 to the corresponding client device 225, the credential 270 being subject to its corresponding TTL values.

Alternatively, as shown in the non-limiting example 200B of FIG. 2B, credential data 265b may include credentials, first TTL values, and second TTL values associated with corresponding MAC address that is associated with a client device among the one or more client devices 225a-225n. The first TTL values are listed as one of an infinite or unlimited period for validity of the first time period, a time period value for validity of the first time period that is listed in years, or a time period value for validity of the first time period that is listed in minutes, one or more hours, one or more days, one or more weeks, or one or more months, or the like. The second TTL values are listed as one of blank or not applicable, or a time period value for validity of the first time period that is listed in years, or a time period value for validity of the first time period that is listed in minutes, hours, days, or weeks, or the like. Although MAC addresses are used as identifiers associated with the client devices 225, other identifiers may also be used, each identifier including, but not limited to, one of a serial number of the client device, a combination of a model number and a device number associated with the client device, an Internet protocol (“IP”) address that is unique and associated with the client device, or the like.

In some aspects, wireless access point device 205 receives, from a client device among the one or more client devices 225a-225n, an authentication request for connection to a wireless network. The wireless access point device 205 determines whether a credential has been associated with the client device. Based on a determination that a temporary credential has been associated with the client device, the wireless access point device 205 sends, to the client device, a prompt to provide a credential. In response to receiving a first credential from the client device, the wireless access point device 205 performs first tasks. The first tasks include determining whether the first credential is valid. The first tasks further include, based on a determination that the first credential is valid, determining whether a first TTL value for the first credential is valid. In some examples, the valid first credential is unique to and associated with an identifier (e.g., a unique MAC address, a (unique) serial number, a (unique) combination of model number and device number, or a unique IP address, etc.) of the client device. The first tasks further include, when the first TTL value for the first credential is valid, approving the authentication request for the client device, establishing a connection between the client device and the wireless network via the wireless access point device, and initiating a first session between the client device and the wireless network. The first tasks further include, when the first TTL value for the first credential is no longer valid, determining whether a second TTL value is valid. The first tasks further include, when the second TTL value for the first credential is valid, approving the authentication request for the client device, re-establishing the connection between the client device and the wireless network via the wireless access point device, and initiating a second session between the client device and the wireless network.

In some embodiments, the first tasks further include, while the first session is active and prior to expiration of the first time period corresponding to the first TTL value, sending, to an administrator device, a first authorization request. In examples, the administrator device includes a client device among the one or more client devices 225a-225n, such as client device 225a having a MAC address (e.g., MAC 1=“AA-00-CC-11-EE-01” as shown in FIG. 2) associated a credential (e.g., “*********9812” as shown in FIG. 2) that has a permanent first TTL value (e.g., “Permanent” as shown in FIG. 2A or “∞” as shown in FIG. 2B), or client device 225b having a MAC address (e.g., MAC 2=“BB-00-DD-11-FF-10” as shown in FIG. 2) associated a credential (e.g., “*********1587” as shown in FIG. 2) that has a long duration first TTL value (e.g., “20500101 23:59:59” as shown in FIG. 2A or “25 yrs” as shown in FIG. 2B), or the like. The first tasks further include receiving, from the administrator device, a first authorization response indicating whether to extend the first time period while the first session is continuing, by changing the first TTL value. The first tasks further include, when the first authorization response indicates that the first time period should not be extended, causing the first session to be terminated upon expiration of the first time period corresponding to the first TTL value. Alternatively, the first tasks further include, when the first authorization response indicates that the first time period should be extended, modifying the first TTL value based on the first authorization response to extend the first time period.

According to some embodiments, based on a determination that a credential has not been associated with the client device, the wireless access point device 205 sends, to the client device, a prompt to request a new credential; and, in response to receiving a request for a new credential, performs second tasks. In some examples, the second tasks further include sending, to the administrator device, a second authorization request for establishing a connection between the client device and the wireless network; and receiving, from the administrator device, a second authorization response to the second authorization request; and, based on the second authorization response indicating to provide access to the client device, performing third tasks. The third tasks include generating and associating a second credential for and with the client device; setting a first TTL value for the second credential; setting a second TTL value for the second credential; and sending the second credential to the client device.

In other aspects, the wireless access point device 205 performs other methods for implementing credential management across multiple devices for wireless network access, such as method 300 of FIGS. 3A and 3B or method 400 of FIGS. 4A-4E, as described in detail below.

FIGS. 3A and 3B (collectively, “FIG. 3”) depict flow diagrams illustrating an example method 300 for implementing credential management across multiple devices for wireless network access, in accordance with various embodiments. Method 300 of FIG. 3A continues onto FIG. 3B following the circular marker denoted, “A,” and returns to FIG. 3A either following the circular marker denoted, “B,” or following the circular marker denoted, “C.”

In the non-limiting embodiment of FIG. 3A, method 300, at operation 305, includes receiving, by a wireless access point device and from a client device, an authentication request for connection to a wireless network. At operation 310, method 300 includes determining, by the wireless access point device, whether a credential has been associated with the client device. Based on a determination that the credential is a permanent credential, method 300 continues onto the process at operation 315. Based on a determination that the credential is a temporary credential, method 300 continues onto the process at operation 335. Based on a determination that the credential is a new credential, method 300 continues onto the process at operation 355 in FIG. 3B following the circular marker denoted, “A.” The client device and the wireless access point device are similar to corresponding client device and wireless access point device as described above with respect to FIGS. 1 and 2. The permanent credential and the temporary credential are similar to those as described above with respect to FIGS. 2A and 2B.

At operation 315, method 300 includes sending, by the wireless access point device and to the client device, a prompt to provide a credential; and, in response to receiving a first credential from the client device, determining, by the wireless access point device, whether the first credential matches a permanent credential (e.g., determining whether the first credential is valid) (at operation 320). Based on a determination that the first credential matches the permanent credential, and thus is determined to be valid, method 300 continues onto the process at operation 325. Based on a determination that the first credential fails to match the permanent credential, and thus is determined to be invalid, method 300 either continues onto the process at operation 330 or continues onto the process at operation 335 following the circular marker denoted, “B.” At operation 325, method 300 includes approving, by the wireless access point device, the authentication request for the client device, establishing, by the wireless access point device, a connection between the client device and the wireless network via the wireless access point device, and initiating, by the wireless access point device, a first session between the client device and the wireless network. Alternatively, at operation 330, method 300 includes denying the authentication request, which includes denying, by the wireless access point device, access to the wireless network by the client device.

At operation 335, method 300 includes sending, by the wireless access point device and to the client device, a prompt to provide a credential; and, in response to receiving a second credential from the client device, determining, by the wireless access point device, whether the second credential matches a temporary credential (e.g., determining whether the second credential is valid) (at operation 340). Based on a determination that the second credential matches the temporary credential, and thus is determined to be valid, method 300 continues onto the process at operation 345. Based on a determination that the second credential fails to match the temporary credential, and thus is determined to be invalid, method 300 continues onto the process at operation 330. At operation 345, method 300 includes, based on a determination that the second credential is valid, determining, by the wireless access point device, whether a first TTL value for the second credential is valid, wherein the valid second credential is unique to and associated with an identifier of the client device. When the first TTL value for the second credential is valid, method 300 continues onto the process at operation 325. When the first TTL value for the second credential is invalid, method 300 continues onto the process at operation 350, at which method 300 includes determining, by the wireless access point device, whether a second TTL value for the second credential is valid. When the second TTL value for the second credential is valid, method 300 continues onto the process at operation 325, at which the authentication request is approved, the connection between the client device and the wireless network is established, and the second session between the client device and the wireless network is initiated. When the second TTL value for the second credential is invalid, method 300 continues onto the process at operation 330, at which the authentication request is denied, resulting in access to the wireless network by the client device being denied. In examples, the temporary credentials may be automatically removed or caused to be deleted from the client device.

At operation 355 in FIG. 3B (following the circular marker denoted, “A,” in FIG. 3A), method 300 includes sending, by the wireless access point device and to an administrator device, a first authorization request for establishing a connection between the client device and the wireless network. Method 300 further includes, at operation 360, receiving, by the wireless access point device and from the administrator device, a first authorization response to the first authorization request. Based on the first authorization response indicating to deny access to the client device, method 300 continues onto the process at operation 330 following the circular marker denoted, “C.” Based on the first authorization response indicating to provide access to the client device, method 300 continues onto the process at operation 365.

At operation 365, method 300 includes generating and associating, by the wireless access point device, a third credential for and with the client device. Method 300 further includes, at operation 370, sending, by the wireless access point device, the third credential to the client device. Method 300 returns to the process at operation 335 in FIG. 3A following the circular marker denoted, “B.” Alternatively, at operation 375, method 300 includes setting, by the wireless access point device, a first TTL value for the third credential. In some instances, the first TTL value corresponds to a first time period, during which the third credential is valid, the first time period corresponding to a duration of a first session between the client device and the wireless access point device. At operation 380, method 300 includes setting, by the wireless access point device, a second TTL value for the third credential. In some cases, the second TTL value corresponds to a second time period, during which the third credential is valid, a start of the second time period following termination of the first time period. In some instances, setting the first TTL value and the second TTL value for the third credential are based on the first authorization response indicating to provide access to the client device. In some examples, the method 300 further includes, at operation 385, storing, in a data storage device, the third credential, the first TTL value, and the second TTL value, the third credential being associated with an identifier that is associated with the client device. Method 300 continues onto the process at operation 370, and subsequently returns to the process at operation 335 in FIG. 3A following the circular marker denoted, “B.”

FIGS. 4A-4E (collectively, “FIG. 4”) depict flow diagrams illustrating another example method 400 for implementing credential management across multiple devices for wireless network access, in accordance with various embodiments. Method 400 of FIG. 4A continues onto FIG. 4C following the circular marker denoted, “A,” and returns to FIG. 4A either following the circular marker denoted, “F,” or following the circular marker denoted, “C.” Method 400 of FIG. 4A either continues onto FIG. 4D following the circular marker denoted, “B,” and returns to FIG. 4A either following the circular marker denoted, “F,” or following the circular marker denoted, “C.” Method 400 of FIG. 4A continues onto FIG. 4B either following the circular marker denoted, “D,” or following the circular marker denoted, “E,” and returns to FIG. 4A either following the circular marker denoted, “F,” or following the circular marker denoted, “C.” Method 400 of FIG. 4A continues onto FIG. 4E following the circular marker denoted, “G,” and returns to FIG. 4A either following the circular marker denoted, “F,” or following the circular marker denoted, “C.”

In the non-limiting embodiment of FIG. 4A, method 400, at operation 402, includes receiving, by a wireless access point device and from a client device, a first authentication request for connection to a wireless network. At operation 404, method 400 includes sending, by the wireless access point device and to the client device, a prompt to either provide a credential or to request a new credential. In response to receiving a request for a new credential, method 400 continues onto the process at operation 406. In response to receiving a permanent credential, method 400 continues onto the process at operation 440 in FIG. 4C following the circular marker denoted, “A.” In response to receiving a temporary credential, method 400 continues onto the process at operation 444 in FIG. 4D following the circular marker denoted, “B.” The client device and the wireless access point device are similar to corresponding client device and wireless access point device as described above with respect to FIGS. 1 and 2. The permanent credential and the temporary credential are similar to those as described above with respect to FIGS. 2A and 2B.

At operation 406, method 400 includes sending, by the wireless access point device and to an administrator device, a first authorization request for establishing a connection between the client device and the wireless network. Method 400 further includes, at operation 408, receiving, by the wireless access point device and from the administrator device, a first authorization response to the first authorization request. Based on the first authorization response indicating to deny access to the client device, method 400 continues onto the process at operation 426 following the circular marker denoted, “C.” Based on the first authorization response indicating to provide access to the client device, method 400 continues onto the process at operation 410.

At operation 410, method 400 includes generating and associating, by the wireless access point device, a first credential for and with the client device. Method 400 further includes, at operation 412, setting, by the wireless access point device, a first TTL value for the first credential. In some instances, the first TTL value corresponds to a first time period, during which the first credential is valid, the first time period corresponding to a duration of a first session between the client device and the wireless access point device. In some examples, method 400 continues onto the process at operation 414. In other examples, method 400 continues onto the process at operation 418. At operation 414, method 400 includes setting, by the wireless access point device, a second TTL value for the first credential. In some cases, the second TTL value corresponds to a second time period, during which the first credential is valid, a start of the second time period following termination of the first time period. In some instances, setting the first TTL value and the second TTL value for the first credential are based on the first authorization response indicating to provide access to the client device. In some examples, the method 400 further includes, at operation 416, storing, in a data storage device, the first credential, the first TTL value, and the second TTL value, the first credential being associated with an identifier that is associated with the client device. Method 400 continues onto the process at operation 418. At operation 418, following the process at operation 412 or the process at operation 416, method 400 includes sending, by the wireless access point device, the first credential to the client device.

At operation 420, method 400 includes receiving, by the wireless access point device, a second authentication request from the client device, including the first credential. Method 400 further includes, at operation 422, determining, by the wireless access point device, whether the first TTL value for the first credential is valid. Based on a determination that the first TTL value is valid, method 400 continues onto the process at operation 424. Based on a determination that the first TTL value is invalid, method 400 either continues onto the process at operation 426 following the circular marker denoted, “C,” or continues onto the process at operation 452 in FIG. 4E following the circular marker denoted, “G.” At operation 452 in FIG. 4E (following the circular marker, denoted, “G”), method 400 includes determining, by the wireless access point device, whether the second TTL value for the first credential is valid. Based on a determination that the second TTL value is valid, method 400 continues onto the process at operation 424 in FIG. 4A following the circular marker denoted, “F.” Based on a determination that the second TTL value is invalid, method 400 continues onto the process at operation 426 following the circular marker denoted, “C.”

At operation 424, following the process at operation 422 or following the circular marker denoted, “F,” method 400 includes, when the first TTL value for the first credential is valid, approving, by the wireless access point device, the second authentication request for the client device, establishing, by the wireless access point device, a connection between the client device and the wireless network via the wireless access point device, and initiating, by the wireless access point device, a first session between the client device and the wireless network. Method 400 either continues onto the process at operation 428 following the circular marker denoted, “D,” or continues onto the process at operation 436 following the circular marker denoted, “E.” At operation 426, following the circular marker denoted, “C,” method 400 includes denying the second authentication request, which includes denying, by the wireless access point device, access to the wireless network by the client device.

At operation 428 in FIG. 4B (following the circular marker denoted, “D,” in FIG. 4A), method 400 includes, prior to expiration of the first time period corresponding to the first TTL value, sending, by the wireless access point device and to the administrator device, a second authorization request. Method 400 further includes, at operation 430, receiving, by the wireless access point device and from the administrator device, a second authorization response indicating whether to extend the first time period while the first session is continuing, by changing the first TTL value. Method 400 further includes, when the second authorization response indicates that the first time period should not be extended, causing, by the wireless access point device, the first session to be terminated upon the expiration of the first time period corresponding to the first TTL value (at operation 432). Alternatively, the method further includes, when the second authorization response indicates that the first time period should be extended, modifying, by the wireless access point device, the first TTL value based on the second authorization response to extend the first time period (at operation 434). Method 400 continues onto the process at operation 436.

At operation 436 (either following the process at operation 434 or following the circular marker denoted, “E,” in FIG. 4A), method 400 includes, based on a determination that the first session has terminated, receiving, by the wireless access point device, a third authentication request from the client device, including the first credential. Method 400 further includes determining, by the wireless access point device, whether the second TTL value for the first credential is valid (at operation 438). Based on a determination that the second TTL value is valid, method 400 continues onto the process at operation 424 in FIG. 4A following the circular marker denoted, “F.” In this case, method 400 further includes, when the second TTL value for the first credential is valid, approving, by the wireless access point device, the third authentication request for the client device, re-establishing, by the wireless access point device, a connection between the client device and the wireless network via the wireless access point device, and initiating a second session between the client device and the wireless network. Based on a determination that the second TTL value is invalid, method 400 continues onto the process at operation 426 in FIG. 4A following the circular marker denoted, “C.” In this case, method 400 further includes, denying the third authentication request, which includes denying, by the wireless access point device, access to the wireless network by the client device.

At operation 440 (following the circular marker denoted, “A,” in FIG. 4A), method 400 includes receiving, by the wireless access point device, a second credential. Method 400, at operation 442, includes determining, by the wireless access point device, whether the second credential matches a permanent credential. In examples, the permanent credential has a first TTL value that corresponds to one of a permanent first time period, an extended first time period, an automatically resetting first time period, or a periodically resetting first time period, or the like. Based on a determination that the second credential matches the permanent credential, method 400 continues onto the process at operation 424 in FIG. 4A following the circular marker denoted, “F.” In this case, method 400 further includes approving, by the wireless access point device, the first authentication request for the client device, establishing, by the wireless access point device, a connection between the client device and the wireless network via the wireless access point device, and initiating, by the wireless access point device, a first session between the client device and the wireless network. Based on a determination that the second credential fails to match the permanent credential, method 400 continues onto the process at operation 426 in FIG. 4A following the circular marker denoted, “C.” In this case, method 400 further includes, denying the first authentication request, which includes denying, by the wireless access point device, access to the wireless network by the client device.

At operation 444 (following the circular marker denoted, “B,” in FIG. 4A), method 400 includes receiving, by the wireless access point device, a third credential. Method 400, at operation 446, includes determining, by the wireless access point device, whether the third credential matches a temporary credential. In some cases, the temporary credential has a first TTL value that corresponds to a finite-duration first time period or limited-duration first time period. Based on a determination that the third credential fails to match the temporary credential, method 400 continues onto the process at operation 426 in FIG. 4A following the circular marker denoted, “C.” In this case, method 400 further includes, denying the first authentication request, which includes denying, by the wireless access point device, access to the wireless network by the client device. Based on a determination that the third credential matches the temporary credential, method 400 continues onto the process at operation 448. At operation 448, method 400 includes determining, by the wireless access point device, whether a first TTL value for the third credential is valid. Based on a determination that the first TTL value is valid, method 400 continues onto the process at operation 424 in FIG. 4A following the circular marker denoted, “F.” In this case, method 400 further includes approving, by the wireless access point device, the first authentication request for the client device, establishing, by the wireless access point device, a connection between the client device and the wireless network via the wireless access point device, and initiating, by the wireless access point device, a first session between the client device and the wireless network. Based on a determination that the first TTL value is invalid, method 400 continues onto the process at operation 450. At operation 450, method 400 includes determining, by the wireless access point device, whether a second TTL value for the third credential is valid. Based on a determination that the second TTL value is valid, method 400 continues onto the process at operation 424 in FIG. 4A following the circular marker denoted, “F.” In this case, method 400 further includes approving, by the wireless access point device, the first authentication request for the client device, re-establishing, by the wireless access point device, a connection between the client device and the wireless network via the wireless access point device, and initiating, by the wireless access point device, a second session between the client device and the wireless network. Based on a determination that the second TTL value is invalid, method 400 continues onto the process at operation 426 in FIG. 4A following the circular marker denoted, “C.” In this case, method 400 further includes, denying the first authentication request, which includes denying, by the wireless access point device, access to the wireless network by the client device.

While the techniques and procedures are depicted and/or described in a certain order for purposes of illustration, it should be appreciated that certain procedures may be reordered and/or omitted within the scope of various embodiments. Moreover, while the methods 300 and 400 illustrated by FIGS. 3 and 4, respectively, can be implemented by or with (and, in some cases, are described below with respect to) the systems, examples, or embodiments 100, 200A, and 200B of FIGS. 1, 2A, and 2B, respectively (or components thereof), such methods may also be implemented using any suitable hardware (or software) implementation. Similarly, while each of the systems, examples, or embodiments 100, 200A, and 200B of FIGS. 1, 2A, and 2B, respectively (or components thereof), can operate according to the methods 300 and 400 illustrated by FIGS. 3 and 4, respectively (e.g., by executing instructions embodied on a computer readable medium), the systems, examples, or embodiments 100, 200A, and 200B of FIGS. 1, 2A, and 2B can each also operate according to other modes of operation and/or perform other suitable procedures.

### Exemplary System and Hardware Implementation

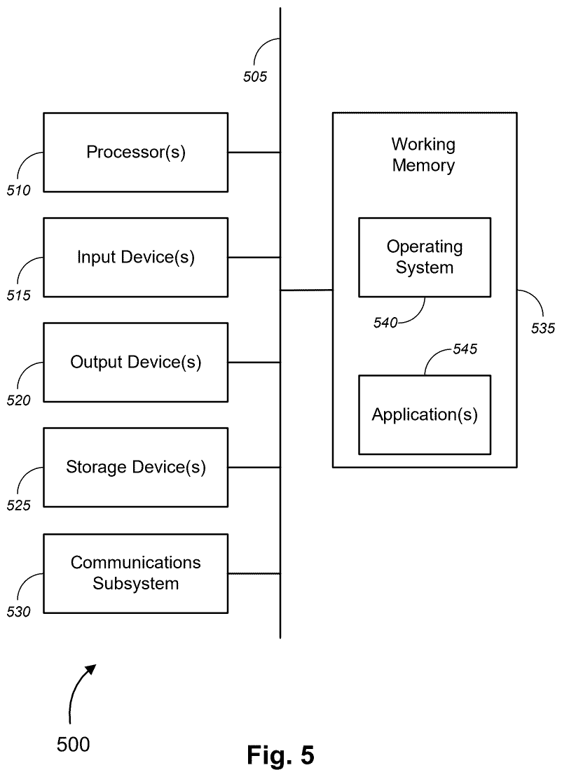

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., wireless access point devices 105 and 205, IoT devices 120a-120m, client devices 125a-125n and 225a-225n, and Wi-Fi router 255, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., wireless access point devices 105 and 205, IoT devices 120a-120m, client devices 125a-125n and 225a-225n, and Wi-Fi router 255, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infrared communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for case of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for case of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with-or without-certain features for case of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a wireless access point device and from a client device, a first authentication request for connection to a wireless network;
sending, by the wireless access point device and to the client device, a prompt to either provide a credential or to request a new credential; and
in response to receiving a request for a new credential, performing first tasks including:
sending, by the wireless access point device and to an administrator device, a first authorization request for establishing a connection between the client device and the wireless network;
receiving, by the wireless access point device and from the administrator device, a first authorization response to the first authorization request;
based on the first authorization response indicating to provide access to the client device, performing second tasks including:
generating and associating, by the wireless access point device, a first credential for and with the client device;
setting, by the wireless access point device, a first time-to-live (“TTL”) value for the first credential; and
sending, by the wireless access point device, the first credential to the client device; and
receiving, by the wireless access point device, a second authentication request from the client device, including the first credential;
determining, by the wireless access point device, whether the first TTL value for the first credential is valid; and
when the first TTL value for the first credential is valid, approving, by the wireless access point device, the second authentication request for the client device, and establishing, by the wireless access point device, a connection between the client device and the wireless network via the wireless access point device.

2. The method of claim 1, wherein the first credential is a temporary unique credential that is unique to and associated with a media access control (“MAC”) address of the client device.

3. The method of claim 1, wherein the first TTL value corresponds to a first time period, during which the first credential is valid, the first time period corresponding to a duration of a first session between the client device and the wireless access point device, wherein the second tasks further include:
setting, by the wireless access point device, a second TTL value for the first credential, wherein the second TTL value corresponds to a second time period, during which the first credential is valid, a start of the second time period following termination of the first time period.

4. The method of claim 3, wherein setting the first TTL value and the second TTL value for the first credential are based on the first authorization response indicating to provide access to the client device.

5. The method of claim 3, wherein the second tasks further include:
storing, in a data storage device, the first credential, the first TTL value, and the second TTL value, the first credential being associated with an identifier that is associated with the client device.

6. The method of claim 3, further comprising:
when the first TTL value for the first credential is valid, initiating, by the wireless access point device, the first session;
prior to expiration of the first time period corresponding to the first TTL value, sending, by the wireless access point device and to the administrator device, a second authorization request;
receiving, by the wireless access point device and from the administrator device, a second authorization response indicating whether to extend the first time period while the first session is continuing, by changing the first TTL value;
when the second authorization response indicates that the first time period should not be extended, causing, by the wireless access point device, the first session to be terminated upon the expiration of the first time period corresponding to the first TTL value; and
when the second authorization response indicates that the first time period should be extended, modifying, by the wireless access point device, the first TTL value based on the second authorization response to extend the first time period.

7. The method of claim 3, further comprising:
based on a determination that the first session has terminated, receiving, by the wireless access point device, a third authentication request from the client device, including the first credential;
determining, by the wireless access point device, whether the second TTL value for the first credential is valid; and
when the second TTL value for the first credential is valid, approving, by the wireless access point device, the third authentication request for the client device, and re-establishing, by the wireless access point device, a connection between the client device and the wireless network via the wireless access point device.

8. The method of claim 1, further comprising:
in response to receiving a second credential, performing third tasks including:
determining, by the wireless access point device, whether the second credential matches a permanent credential or a temporary credential; and
based on a determination that the second credential matches one of the permanent credential or the temporary credential, approving, by the wireless access point device, the first authentication request for the client device, and establishing, by the wireless access point device, a connection between the client device and the wireless network via the wireless access point device.

9. The method of claim 8, wherein the permanent credential has a first TTL value that corresponds to one of a permanent first time period, an extended first time period, an automatically resetting first time period, or a periodically resetting first time period, wherein the temporary credential has a first TTL value that corresponds to a finite-duration first time period or limited-duration first time period.

10. The method of claim 1, wherein the client device includes one of a user device, an Internet of Things (“IoT”) device, or an appliance, wherein the user device includes one of a desktop computer, a laptop computer, a tablet computer, a smart phone, or a portable gaming device, wherein the IoT device includes one of a wireless network-capable sensor device, a wireless network-capable light bulb, or a wireless network-capable appliance, wherein the appliance or wireless network-capable appliance includes one of a wireless network-capable home office device, a wireless network-capable kitchen appliance, a wireless network-capable entertainment system, a wireless network-capable security system, or a wireless network-capable home appliance.

11. The method of claim 1, wherein the administrator device includes an administrator user device including one of a desktop computer, a laptop computer, a tablet computer, or a smart phone.

12. The method of claim 1, wherein generating the first credential comprises one of:
receiving a temporary password from the administrator device and generating the first credential based on the temporary password;
automatically generating a random temporary password; or
hashing a permanent password of the wireless network with a media access control (“MAC”) address of the client device.

13. A wireless access point device, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the wireless access point device to:
receive, from a client device, an authentication request for connection to a wireless network;
send, to the client device, a prompt to provide a credential;
in response to receiving a first credential from the client device, performing first tasks including:
determining whether the first credential is valid;
based on a determination that the first credential is valid, determining whether a first time-to-live (“TTL”) value for the first credential is valid, wherein the valid first credential is unique to and associated with an identifier of the client device;
when the first TTL value for the first credential is valid, approving the authentication request for the client device, establishing a connection between the client device and the wireless network via the wireless access point device, and initiating a first session between the client device and the wireless network, wherein the first TTL value includes a first time period corresponding to the first session;
when the first TTL value for the first credential is no longer valid, determining whether a second TTL value is valid, the second TTL value corresponding to a second time period, during which the first credential is valid, a start of the second time period following termination of the first time period;
when the second TTL value for the first credential is valid, approving the authentication request for the client device, re-establishing the connection between the client device and the wireless network via the wireless access point device, and initiating a second session between the client device and the wireless network; and
when the first credential is not valid or when both the first and second TTL values are not valid, denying the client device access to the wireless network.

14. The wireless access point device of claim 13, wherein the identifier includes a media access control (“MAC”) address of the client device.

15. The wireless access point device of claim 13, wherein the first tasks further include:
while the first session is active and prior to expiration of the first time period corresponding to the first TTL value, sending, to an administrator device, an authorization request;
receiving, from the administrator device, an authorization response indicating whether to extend the first time period while the first session is continuing, by changing the first TTL value;
when the authorization response indicates that the first time period should not be extended, causing the first session to be terminated upon expiration of the first time period corresponding to the first TTL value; and
when the authorization response indicates that the first time period should be extended, modifying the first TTL value based on the authorization response to extend the first time period.

16. A method, comprising:
receiving, by a wireless access point device and from a client device, an authentication request for connection to a wireless network;
determining, by the wireless access point device, whether a credential has been associated with the client device;
based on a determination that a temporary credential has been associated with the client device, sending, by the wireless access point device and to the client device, a prompt to provide a credential;
in response to receiving a first credential from the client device, performing first tasks including:
determining, by the wireless access point device, whether the first credential is valid;
based on a determination that the first credential is valid, determining whether a first time-to-live (“TTL”) value for the first credential is valid, wherein the valid first credential is unique to and associated with an identifier of the client device; and
when the first TTL value for the first credential is valid, approving the authentication request for the client device, establishing a connection between the client device and the wireless network via the wireless access point device, and initiating a first session between the client device and the wireless network, wherein the first TTL value includes a first time period corresponding to the first session.

17. The method of claim 16, wherein the identifier includes a media access control (“MAC”) address of the client device.

18. The method of claim 16, wherein the first tasks further include:
when the first TTL value for the first credential is no longer valid, determining, by the wireless access point device, whether a second TTL value is valid, the second TTL value corresponding to a second time period, during which the first credential is valid, a start of the second time period following termination of the first time period; and
when the second TTL value for the first credential is valid, approving, by the wireless access point device, the authentication request for the client device, re-establishing, by the wireless access point device, the connection between the client device and the wireless network via the wireless access point device, and initiating, by the wireless access point device, a second session between the client device and the wireless network.

19. The method of claim 16, wherein the first tasks further include:
while the first session is active and prior to expiration of the first time period corresponding to the first TTL value, sending, by the wireless access point device and to an administrator device, a first authorization request;
receiving, by the wireless access point device and from the administrator device, a first authorization response indicating whether to extend the first time period while the first session is continuing, by changing the first TTL value;
when the first authorization response indicates that the first time period should not be extended, causing, by the wireless access point device, the first session to be terminated upon expiration of the first time period corresponding to the first TTL value; and
when the first authorization response indicates that the first time period should be extended, modifying, by the wireless access point device, the first TTL value based on the first authorization response to extend the first time period.

20. The method of claim 16, further comprising:
based on a determination that a credential has not been associated with the client device, sending, by the wireless access point device and to the client device, a prompt to request a new credential; and
in response to receiving a request for a new credential, performing second tasks including:
sending, by the wireless access point device and to an administrator device, a second authorization request for establishing a connection between the client device and the wireless network;
receiving, by the wireless access point device and from the administrator device, a second authorization response to the second authorization request; and
based on the second authorization response indicating to provide access to the client device, performing third tasks including:
generating and associating, by the wireless access point device, a second credential for and with the client device;
setting, by the wireless access point device, a first TTL value for the second credential;
setting, by the wireless access point device, a second TTL value for the second credential; and
sending, by the wireless access point device, the second credential to the client device.
